(19) United States
(12) Patent Application Publication
(10) Pub. No.: US 2009/0063410 A1
(43) Pub. Date: Mar. 5, 2009

(54) Method for Performing Parallel Data Indexing Within a Data Storage System

(76) Inventors: Nils Haustein, Soergenloch (DE); Craig A. Klein, Tucson, AZ (US); Daniel J. Winarski, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/846,958

(22) Filed: Aug. 29, 2007

(51) Int. Cl. G06F 17/30

(52) U.S. Cl. 707/3; 707/7; 707/E17.002; 707/E17.008

(57) ABSTRACT

A method for performing parallel data indexing within a data storage system is disclosed. After the receipt of a group of data objects, the data objects are copied to an indexing module. Next, the copy of data objects within the indexing module are indexed by the indexing module while the data objects are being stored within a storage medium. The indices of the copy of data objects within the indexing module are stored in an index repository within the indexing module.

### BACKGROUND OF THE INVENTION

1. Technical Field

The present invention relates to data storage systems in general, and more particularly, to a method for performing parallel data indexing within a data storage system.

2. Description of Related Art

A data storage system is commonly employed to store data objects that includes files of different formats. Data indexing, especially full text indexing, allows data objects to be searched and found based on their attributes and contents in an efficient manner. Thus, data indexing is an important feature for data archiving.

Data indexing is currently performed by enterprise content management (ECM) systems such as DB2 Content Manager offered by International Business Machines of Armonk, N.Y. Indexed data are typically stored in a repository, such as a database, associated with a particular ECM system.

A full-text indexing operation is commonly executed in the background of an ECM system according to specific schedules. A full-text index for a particular data object can be generated after the data object has been received and stored in a destination storage medium within an ECM system. Other index information, including data object attributes (such as name, size, owner, etc.), are also stored in an ECM repository.

Indexing can also be performed by applications of their respective data files within a file system. A full-text index for a data file is generated after the data file has been stored within the file system, and the indexed data is stored in a repository.

The present disclosure provides an improved method for providing parallel data indexing within a data storage system.

### SUMMARY OF THE INVENTION

In accordance with a preferred embodiment of the present invention, after the receipt of a group of data objects, the data objects are copied to an indexing module. Next, the copy of data objects within the indexing module are indexed by the indexing module while the data objects are being stored within a storage medium. The indices of the copy of data objects are stored in an index repository within the indexing module.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a data storage system, according to the prior art;

FIG. 2 is a block diagram of a data storage system, in accordance with a preferred embodiment of the present invention; and

FIG. 3 is a high-level logic flow diagram of a method for performing parallel data indexing within the data storage system of FIG. 2, in accordance with a preferred embodiment of the present invention.

### DETAILED DESCRIPTION OF A PREFERRED EMBODIMENT

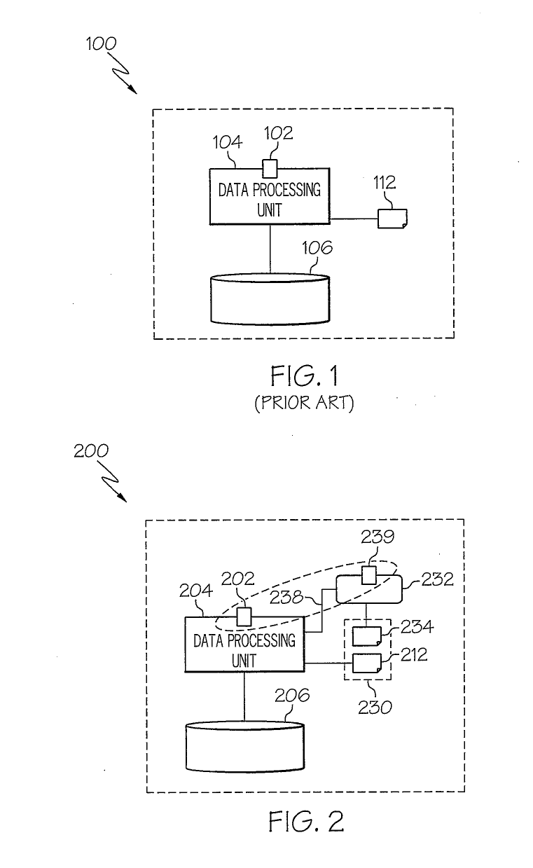

With reference now to the drawings, and in particular to FIG. 1, there is illustrated a block diagram of a data storage system, according to the prior art. As shown, a data storage system 100 includes a data processing unit 104 capable of receiving data via a data interface 102. After receiving a data object from data interface 102, data processing unit 104 stores the data object within a storage medium 106. In addition, data processing unit 104 stores a reference to the data object within a reference repository 112.

The present invention provides a method for performing parallel or on-the-fly indexing and full-text indexing on data objects stored within a data storage system. For the purpose of the present invention, on-the-fly indexing is defined as indexing being performed in parallel (or concurrently) with the data storing process and not after the data has been stored.

With reference now to FIG. 2, there is depicted a block diagram of a data storage system, in accordance with a preferred embodiment of the present invention. As shown, a data storage system 200 includes a data processing unit 204 capable of receiving data via a data interface 202. Data interface 202 supports file system protocols (such as JFS, GPFS), network file system protocols (such as NFS, CIFS) or application programming interfaces (such as Tivoli Storage Manager API).

After receiving a data object from data interface 202, data processing unit 204 stores the data object within a storage medium 206. Storage medium 206 can be a disk drive, a disk array, a magnetic tape cartridge, an optical medium, etc. In addition, data processing unit 204 stores a reference to the data object within a reference repository 212. The reference to the data block, which is generally referred to as metadata, essentially maps the data object to a storage location (i.e., a logical block address) within storage medium 206. Reference repository 212 may also be utilized to store additional attributes of the data object, such as data and time of storage, user name and access control information.

Data storage system 200 also includes an indexing module 232 for providing data indexing on-the-fly. Indexing module 232 is connected to data processing unit 204 via a link 238. Link 238 may be a shared memory or a communication link realized through TCP/IP, GbEN, Fibre Channel, or other communication protocols. Indexing module 232 includes an index repository 234 that is utilized to maintain index information. Index repository 234 can be combined with reference repository 212 to form a combined repository 230. Indexing module 232 also includes a search interface 239 that can be combined with data interface 202 of data processing unit 204.

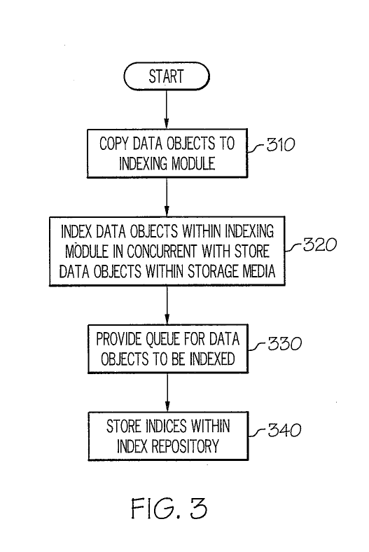

Referring now to FIG. 3, there is depicted a high-level logic flow diagram of a method for performing parallel data indexing within data storage system 200, in accordance with a preferred embodiment of the present invention. After receiving a group of data objects, data processing unit 204 immediately copies the data objects to indexing module 232 via link 238, as shown in block 310. Afterwards, indexing module 232 starts indexing its data objects while data processing unit 204 proceeds to store the data objects within storage medium 206, as depicted in block 320. Indexing module 232 may provide a queue for the data objects to be indexed at link 238, as shown in block 330. After the indices had been generated, indexing module 232 stores those indices within index repository 234, as depicted in block 340. The indices within index repository 234 can be combined with reference repository 212.

By creating an index for a data object, such as a full text index, efficient searches are made possible. The search is initiated through search interface 239 that may be combined with data interface 202. A search request issued via search interface 239 may require finding all data objects including a certain text-pattern, such as the words “color wheel.” The search request is received by indexing module 232 that immediately consults index repository 234 in order to find all objects including subject pattern. All search results are reported to search interface 239 to allow a user or application to access any found data objects.

Indexing module 232 may be executed on a separate server, or on a separate logical partition of a given server, or as a separate process within a server. Indexing, in particular full text indexing, is a time-intensive operation. Thus, more computing resources such as processor, memory, bus-bandwidth can be added to the on-the-fly indexing system in an on-demand manner. For example, if an indexing system runs at or near 100% processor utilization, the indexing system can send an alert to a user to provide more resources. The user may provide more resources such as more processors. As such, the user has direct influence on the indexing performance of data storage system 200.

The method of the present invention can perform indexing on-the-fly, which is faster than the traditional method of indexing. By combining metadata and index data repository in a storage system, the present invention reduces the complexity because there is one less repository to maintain. In addition, the present invention enables an all-inclusive backup or mirror within storage medium 206.

As has been described, the present invention provides a method for providing parallel data indexing within a data storage system. Advantages of the method of the present invention include
data indexes are generated during data is being stored in a storage system, and not later;
no additional infrastructure, such as separate application with extra repository, is required;
value-add functionality for the storage system because it compliments the traditional storage system;
no additional interface is required for data indexing because the data interface of the storage system is used for searches as well; and
protection of data indexes can be easily combined with protection of actual data and metadata because it is entirely resident within the storage system, which allows for a comprehensive backup, or mirror, in a simple manner.

The present invention is especially applicable for archiving storage systems because data is kept for long times and must be indexed to enable searches. In addition, the present invention is most appropriate for data storage systems providing a file system or object oriented data interface to the application because only such interface allows full-text indexing of files and data-objects by the data storage system.

While an illustrative embodiment of the present invention has been described in the context of a fully functional storage system, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method for performing parallel data indexing within a data storage system, said method comprising:
after the receipt of a plurality of data objects, coping said data objects to an indexing module;
indexing said copy of data objects by said indexing module while storing said data objects within a storage medium; and
storing indices of said copy of data objects in an index repository within said indexing module.

2. The method of claim 1, wherein said method further includes combining said indices in said index repository with indices within a reference repository.

3. The method of claim 1, wherein said method further includes receiving search request from a user via a search interface within said indexing module.

4. The method of claim 1, wherein said storage medium is a hard drive.

5. A computer readable medium having a computer program product for performing parallel data indexing within a data storage system, said computer readable medium comprising:
computer program code for coping a plurality of data objects to an indexing module after the receipt of said data objects;
computer program code for indexing said copy of data objects by said indexing module while storing said data objects within a storage medium; and
computer program code for storing indices of said copy of data objects in said indexing module within an index repository.

6. The computer readable medium of claim 5, wherein said computer readable medium further includes computer program code for combining said indices in said index repository with indices within a reference repository.

7. The computer readable medium of claim 5, wherein said computer readable medium further includes computer program code for receiving search request from a user via a search interface within said indexing module.

8. The computer readable medium of claim 1, wherein said storage medium is a hard drive.

9. A data storage system capable of performing parallel data indexing, said data storage system comprising:
a data processing unit for coping a plurality of data objects to an indexing module after the receipt of said data objects;
an indexing module for indexing said copy of data objects while said data processing unit stores said data objects within a storage medium; and
an index repository within said indexing module for storing indices of said copy of data objects.

10. The data storage system of claim 9, wherein said data storage system further includes means for combining said indices in said index repository with indices within a reference repository.

11. The data storage system of claim 9, wherein said data storage system further includes a search interface within said indexing module for receiving search request from a user.

12. The data storage system of claim 9, wherein said storage medium is a hard drive.
